(19) United States
(12) Patent Application Publication
(10) Pub. No.: US 2011/0278043 A1
(43) Pub. Date: Nov. 17, 2011

(54) TRANSMISSION CABLE

(75) Inventors: Shou UEDA, Sakura-shi (JP); Takashi OGASAWARA, Sakura-shi (JP)

(73) Assignee: FUJIKURA LTD., Tokyo (JP)

(21) Appl. No.: 13/195,647

(22) Filed: Aug. 1, 2011

Related U.S. Application Data
(63) Continuation of application No. PCT/JP2010/000844, filed on Feb. 10, 2010.

(30) Foreign Application Priority Data
Feb. 16, 2009 (JP) 2009-032925

(51) Int. Cl. H01B 11/02

(52) U.S. Cl. 174/115

(57) ABSTRACT

A transmission cable of the invention includes a twisted-pair signal wire; a plurality of signal wire pairs; and a power wire pair. The twisted-pair signal wire, the plurality of signal wire pairs, and the power wire pair are bundled together so that the twisted-pair signal wire is surrounded by the plurality of signal wire pairs and the power wire pair when viewed in cross-section vertical to a longitudinal direction thereof.

### CROSS-REFERENCE TO RELATED APPLICATION

This is a Continuation Application of International Application No. PCT/JP2010/000844, filed on Feb. 10, 2010, which claims priority to Japanese Patent Application No. 2009-032925 filed on Feb. 16, 2009. The contents of the aforementioned applications are incorporated herein by reference.

### BACKGROUND OF THE INVENTION

1. Field of the Invention

The present invention relates to a transmission cable in conformity with the USB 3.0 standard, which is a standard for a next-generation universal serial bus (hereinafter, referred to as USB).

2. Description of the Related Art

USB is one of the data transmission path standards for connecting between an electronic device, such as a personal computer, and a peripheral device, and makes connection between devices easier. Currently, the USB 3.0 standard, which realizes a higher communication speed than that of the widely used USB 2.0 standard, is set as a next-generation standard.

A transmission cable which is determined by the USB 3.0 standard has the following specifications.

According to Non-Patent Document 1 described below, the cable for USB 2.0 standard uses a pair of unshielded twisted-pair (UTP, Unshielded Twisted-pair signal wires) cables and a power wire pair including an electric power wire and a ground wire. As shown in FIG. 6, the cable for USB 3.0 standard includes two pairs of shielded differential pair (SDP, Shielded Differential Pair wires) cables 9 in addition to a pair of UTP cables 2 and a power wire pair 4 which are used in the USB 2.0 cable. These two pairs of SDP cables 9 are used as a transmission-only SDP cable and a reception-only SDP cable, respectively. In this manner, due to separation of transmission from reception, transmission is efficiently performed.

As the SDP cable, use of a shielded twisted-pair (STP, Shielded Twisted-pair wire) cable having a drain wire is proposed. Further, inclusions 6 for filling the space between the twisted-pair signal wire 2, such as a UTP cable, and the power wire pair 4 are arranged in the USB 3.0 cable. After bundling these cables together, a shield 7 which is formed of metal foil, a braid of metal conductors, or the like is provided at the outer circumference thereof, and the outer circumference thereof is covered with an outer cover 8, whereby a USB 3.0 cable is constituted. That is, a cable for USB 3.0 standard 11 is a transmission cable having a collective structure in which a plurality of cables having different cross-sectional shapes is bundled together as one cable.

For example, in the following Patent Document 1 and the following Patent Document 2, there is a description of a conventional transmission cable having a collective structure in which a plurality of cables having different cross-sectional shapes is twisted together.

In addition, a transmission cable is disclosed in which, due to the arrangement of an inclusion which is not a signal wire described in the following Patent Document 1 or a tension-resistant member described in the following Patent Document 2 at the center of the transmission cable, the cables can be stably arranged even when these have different cross-sectional shapes.

### Patent Documents

[Patent Document 1] Japanese Unexamined Patent Application, First Publication No. 2002-216550
[Patent Document 2] Japanese Unexamined Patent Application, First Publication No. H11-162268

### Non-Patent Documents

[Non-Patent Document 1] Nikkei Electronics, issued on Oct. 6, 2008, “First Appearance of USB 3.0”, published by Nikkei BP, p. 83 to 92
[Non-Patent Document 2] USB 3.0 Specification, Nov. 12, 2008, Internet <URL: http://www.usb.org/developers/docs/>

The transmission cable 11 in conformity with the typical USB 3.0 standard as shown in FIG. 6 has a collective structure in which the cables 2, 4, and 9 having different cross-sectional shapes are twisted together. Accordingly, even when a plurality of inclusions 6 is inserted in a space 10 to fill the space, the positions of the cables are not stabilized and some of the interior cables have a heavy load. Therefore, there is concern that the cables may be damaged. When an insulated wire of the pair of STP cables 9 is damaged, the balance in the pair of STP cables 9 deteriorates and thus skew increases. Therefore, there is concern that attenuation characteristics may deteriorate. In addition, regarding the UTP cable 2, the impedance is reduced in a portion in which an insulated wire is damaged, whereby there is also concern that impedance mismatching may occur.

In addition, since the positions of the cables are not stabilized, the cross-sectional shape of the overall transmission cable 11 does not become a true circle, and thus there is also concern that the appearance may become worse. In addition, as shown in the above Patent Document 1 and Patent Document 2, when an inclusion which is not a signal wire is arranged at the center of the transmission cable, there is also concern that the outer diameter of the transmission cable may increase.

The present invention was made in view of the above circumstances, and an object thereof is to provide a transmission cable which can prevent a deterioration in attenuation characteristics due to the damage to the cable.

### SUMMARY

The present invention employs the followings to solve the above-described problems and achieve the object.

(1) A transmission cable according to the present invention includes: a twisted-pair signal wire; a plurality of signal wire pairs; and a power wire pair, and the twisted-pair signal wire, the plurality of signal wire pairs, and the power wire pair are bundled together so that the twisted-pair signal wire is surrounded by the plurality of signal wire pairs and the power wire pair when viewed in cross-section vertical to a longitudinal direction thereof.

According to the transmission cable according to (1) above, since the plurality of signal wire pairs and the power wire pair constituting the transmission cable are arranged in a balanced manner, a heavy load is not applied to a part of the interior of the transmission cable and damage to these signal wire pairs and power wire pair is prevented.

(2) The transmission cable according to the (1) above may employ a configuration in which a pair of first inclusions is provided which sandwiches a contact point of the twisted-pair signal wire in between, and the twisted-pair signal wire and the pair of first inclusions are quad-twisted.

According to the transmission cable according to (2) above, since the cross-sectional shape of the twisted-pair signal wire is made close to a true circle by providing the pair of first inclusions, the plurality of signal wire pairs and the power wire pair can be arranged in a balanced manner and damage to these signal wires and power wires is more securely prevented.

(3) In the transmission cable according to (1) above, a second inclusion may be arranged between the respective signal wire pairs and the power wire pair and between the signal wire pairs.

According to the transmission cable according to (3) above, since the plurality of signal wire pairs and the power wire pair can be arranged in a balanced manner due to the arrangement of the second inclusion, damage to these signal wire pairs and power wire pair is more securely prevented.

(4) In the transmission cable according to (1) above, the signal wire pairs may be twin-axial cables.

According to the transmission cable according to (4) above, the outer diameter of the collection of the twisted-pair signal wires, the plurality of twin-axial cables, and the power wire pair bundled together can be reduced.

(5) In the transmission cable according to (1) above, the signal wire pairs may be STP cables.

According to the transmission cable according to (5) above, since no inclusion is arranged at the center of the cable, the outer diameter of the transmission cable can be reduced.

(6) In the transmission cable according to (1) above, the twisted-pair signal wire may be a twisted-pair signal wire constituting a UTP cable for USB 2.0 standard, and the transmission cable may be a USB cable in conformity with USB 3.0 standard.

According to the transmission cable according to (6) above, the transmission cable can be applied to a USB cable in conformity with USB 3.0 standard.

According to a transmission cable of the present invention, it is possible to prevent a deterioration in attenuation characteristics due to the damage thereof and to provide a USB cable in conformity with the USB 3.0 standard.

### BRIEF DESCRIPTION OF THE DRAWINGS

FIG. 1 is a view showing a transmission cable according to a first embodiment of the present invention and is a cross-sectional view when viewed in cross-section vertical to the axial line thereof.

FIG. 2 is a view showing a transmission cable according to a first modified example of the embodiment and is a cross-sectional view matching FIG. 1.

FIG. 3 is a view showing a transmission cable according to a second modified example of the embodiment and is a cross-sectional view matching FIG. 1.

FIG. 4 is a view showing a transmission cable according to a second embodiment of the present invention and is a cross-sectional view when viewed in cross-section vertical to the axial line thereof.

FIG. 5 is a view showing a transmission cable according to a modified example of the embodiment and is a cross-sectional view matching FIG. 4.

FIG. 6 is a view showing a transmission cable in conformity with the typical USB 3.0 standard and is a cross-sectional view when viewed in cross-section vertical to the axial line thereof.

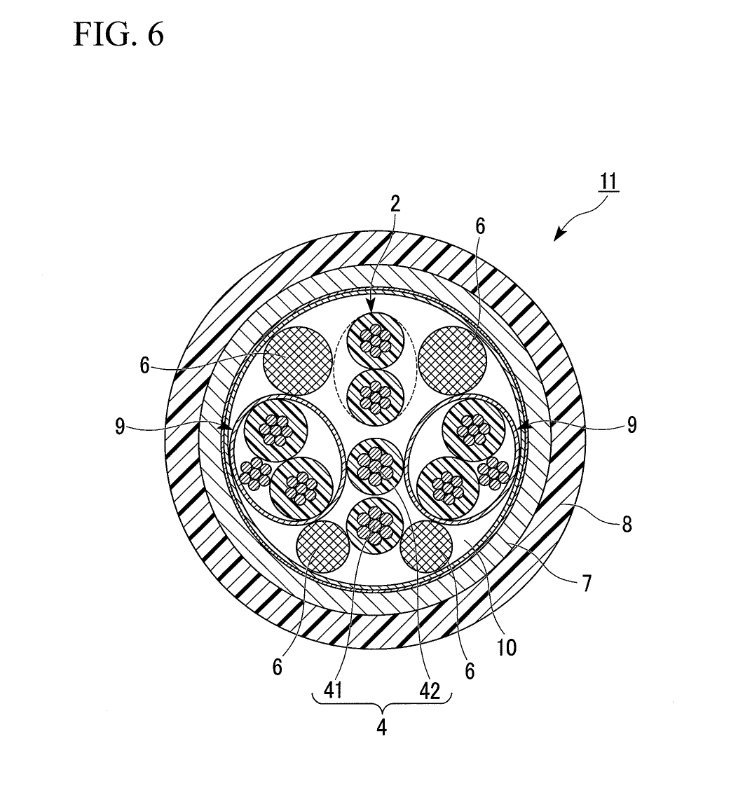

### DETAILED DESCRIPTION OF THE PREFERRED EMBODIMENTS

Hereinafter, embodiments of a transmission cable of the present invention will be described on the basis of drawings.

The present invention is not limited only to the following embodiments, and can be variously changed without departing from the gist of the present invention.

### First Embodiment

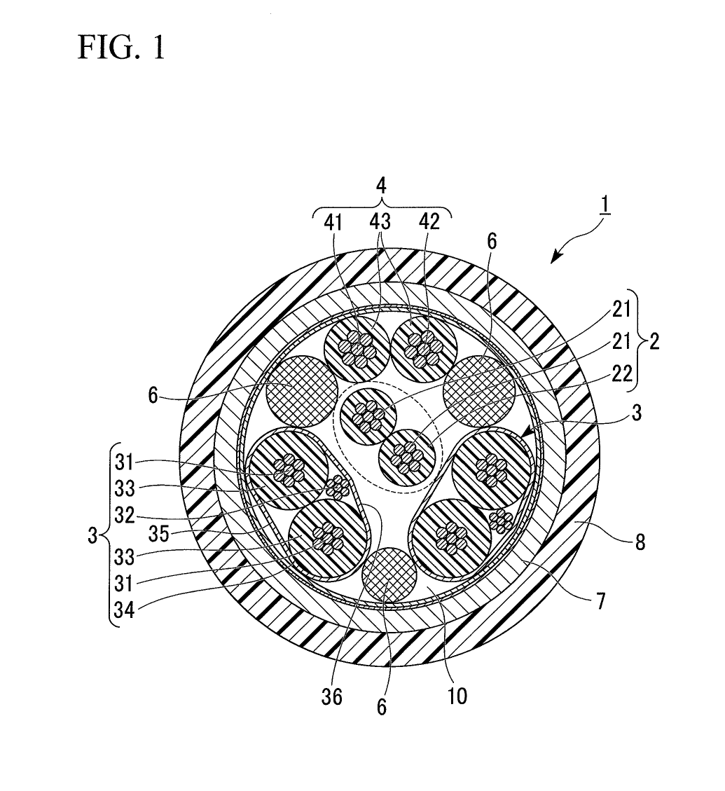

FIG. 1 is a cross-sectional view showing the configuration of a transmission cable 1 according to a first embodiment of the present invention. The transmission cable 1 is a cable in conformity with the USB 3.0 standard.

The transmission cable 1 has a configuration in which a shield material 7 is wound around a collective structure having a twisted-pair signal wire 2 with different outer diameters, two pairs of signal wire pairs 3, a power wire pair 4, and three second inclusions 6 which are arranged between the two pairs of signal wire pairs 3 and the power wire pair 4, and the outer circumference thereof is covered with an outer cover 8.

The twisted-pair signal wire 2 includes a pair of signal wires 21 and the signal wire pair 3 includes a pair of signal wires 31. Each signal wire 21 is covered with an insulating cover 22 and each signal wire 31 is covered with an insulating cover 33. Similarly, each of an electric power wire 41 and a ground wire 42 of the power wire pair 4 is also covered with an insulating cover 43.

The shield material 7 covers the twisted-pair signal wire 2, the two pairs of signal wire pairs 3, the power wire pair 4, and the three second inclusions 6 over the entire lengths thereof. As the shield material 7, a braid of metal conductors or the like is used.

The outer cover 8 covers the outer circumference of the shield material 7. Examples of the material for the outer cover 8 include polyvinyl chloride (PVC), flame-retardant polyethylene (FRPE), modified PPE, and the like. The material for the outer cover 8 may be a material having electric insulating properties and is not limited only to the above-described materials.

The twisted-pair signal wire 2 has a configuration in which a pair of signal wires 21 is respectively covered with an insulating cover 22 and is twisted.

This twisted-pair signal wire 2 is arranged at approximately the center of a cross-section vertical to the longitudinal direction of the transmission cable 1. There is no need to correctly arrange the twisted-pair signal wire 2 at the center of the transmission cable 1, and the twisted-pair signal wire 2 may partially overlap the center point of the transmission cable 1 when viewed in cross-section.

Regarding the size, the signal wire which is used in the twisted-pair signal wire 2 is preferably a cable in the range of AWG 28 to AWG 34. AWG is an abbreviation of American Wire Gauge, and is a standard widely used in the coaxial cable industry.

At the outer circumference of the twisted-pair signal wire 2, the two pairs of signal wire pairs 3 and the power wire pair 4 including the electric power wire 41 and the ground wire 42 are arranged so as to surround the twisted-pair signal wire 2.

The signal wire pair 3 includes the pair of signal wires 31 and a drain wire 32 which is arranged along these signal wires 31. Each of the signal wires 31 is insulated by the insulating cover 33. The drain wire 32 and the signal wires 31 covered with the insulating cover 33 are bundled together as one group and covered with a shield material 34.

The signal wire pair 3 is preferably a twin-axial cable in which signal wires are bundled together parallel to each other, but may be an STP cable which is a twisted-pair wire.

Regarding the size, the signal wire which is used in the signal wire pair 3 is preferably a cable in the range of SWG 28 to SWG 34.

The power wire pair 4 including the electric power wire 41 and the ground wire 42 is arranged so as to come into contact with the twisted-pair signal wire 2 and to be most remote from the two pairs of the signal wire pairs 3. The shield material 7 is wound around the power wire pair 4 and the other cables and the power wire pair 4 comes into contact with this shield material 7.

Regarding the size, the electric power wire 41 and the ground wire 42 are preferably cables in the range of AWG 20 to AWG 28.

The second inclusion 6 having a wire shape with a circular cross-section is arranged between the two pairs of signal wire pairs 3. Similarly, the second inclusions 6 are arranged between the power wire pair 4 and one of the signal wire pairs 3 and between the power wire pair 4 and the other one of the signal wire pairs 3. The shield material 7 is wound around these three second inclusions 6 and the other cables and the second inclusions 6 come into contact with this shield material 7.

The second inclusions 6 fill the space 10 which is generated between the two pairs of signal wire pairs 3 and the power wire pair 4 arranged at the outer circumference of the twisted-pair signal wire 2. Due to the arrangement of the second inclusions 6, the power wire pair 4, the two pairs of signal wire pair 3, and the three second inclusions 6 are arranged around the twisted-pair signal wire 2 so as to form an almost circular cross-sectional shape for the transmission cable 1. In addition, the shield material 7 is wound around the power wire pair 4, the two pairs of signal wire pairs 3, and the three second inclusions 6 and these come into contact with this shield material 7.

The twisted-pair signal wire 2 is arranged at the center of the cable, and among the cables of the transmission cable 1, the two pairs of signal wire pairs 3, the power wire pair 4, and the three second inclusions 6, except the twisted-pair signal wire 2, are arranged so as to cover the circumference thereof in a helical shape.

The outer diameter of the second inclusion is in the range of 0.55 mm to 0.80 mm, and the material thereof is polypropylene (PP). However, the second inclusion is not limited only to this configuration if it has the same functions.

Due to the arrangement of the twisted-pair signal wire 2 at the cable center of the transmission cable 1, a good arrangement balance is achieved when the two pairs of signal wire pairs 3 and the power wire pair 4 are arranged around the twisted-pair signal wire 2 and a heavy load is not applied to a part of the interior of the transmission cable 1, whereby damage to these cables is prevented.

Due to the arrangement of the second inclusions 6 between the signal wire pair 3 and the power wire pair 4 and between the two pairs of signal wire pairs 3, damage to the signal wire pairs 3 is more securely prevented.

Due to not using a twisted-pair wire but using a twin-axial cable in which wires are bundled together parallel to each other in the signal wire pair 3, the outer diameter of the collection of the paired-twisted-pair signal wire 2, the two pairs of twin-axial cables, and the power wire pair 4 bundled together can be reduced. Since the outer diameter of the collection is reduced, the amount of materials used in a braid of metal conductors as the shield material 7 and the outer cover 8 is also reduced.

In addition, since a pair of signal wires is arranged parallel to each other in the twin-axial cable, skew can be easily reduced in comparison to the case of a twisted-pair signal wire.

In addition, since the twin-axial cable is a cable in which signal wires are straight, the length of the signal wire per unit length of the completed transmission cable 1 is shorter than in the case of a twisted cable. Accordingly, the amount of conductors which are used can be reduced.

In addition, since the inclusion is not arranged at the cable center of the transmission cable 1, the outer diameter of the cable can be reduced.

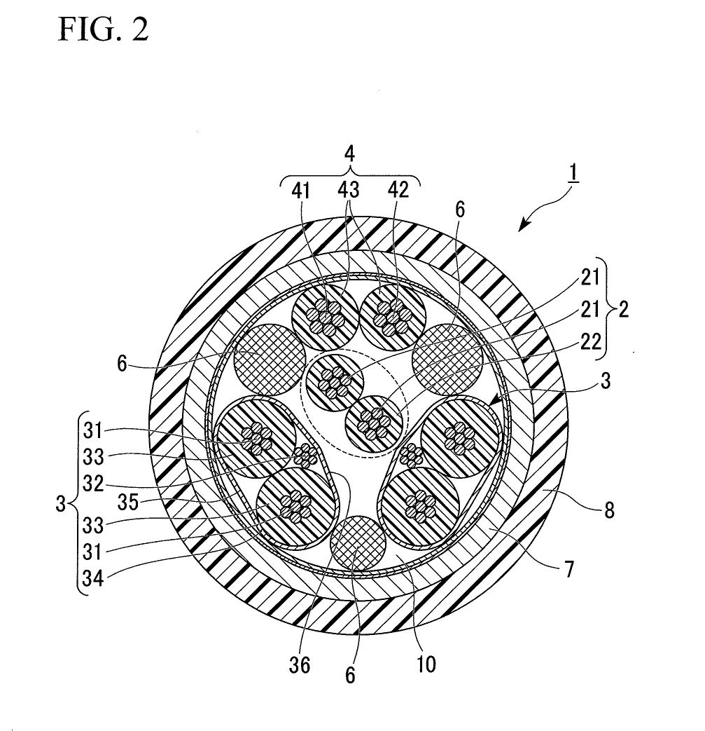

FIG. 2 is a cross-sectional view showing a transmission cable according to a first modified example of the embodiment.

In this first modified example, both pairs of signal wire pairs 3 are arranged so that a flat surface 35 among the surfaces constituting the outer circumference comes into contact with the inner circumferential surface of a shield material 7. A surface 36, which is on the opposite side to the surface 35, among the outer circumferential surfaces of the two pairs of signal wire pairs 3 comes into contact with a twisted-pair signal wire 2.

According to this configuration, since the cables of a transmission cable 1 are arranged in a more balanced manner, damage to these cables is prevented.

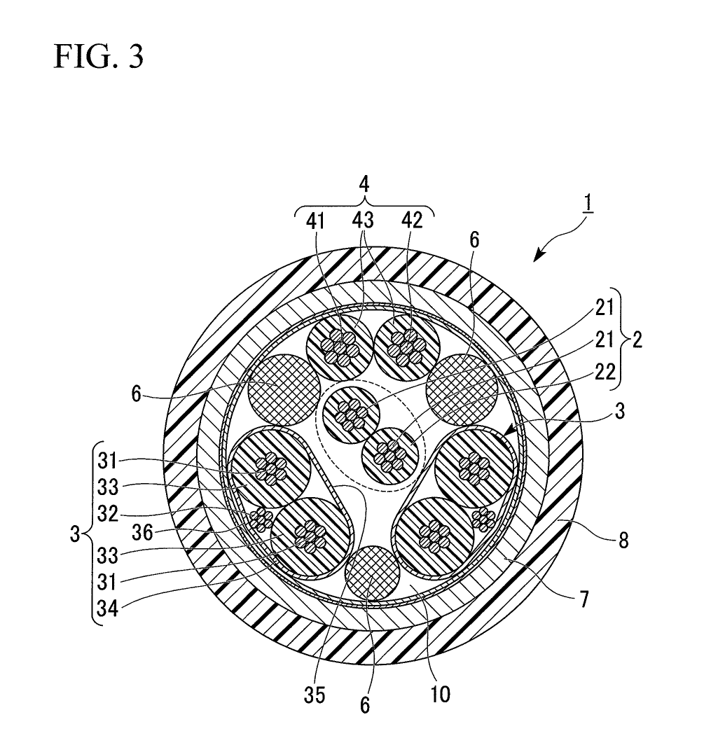

FIG. 3 is a cross-sectional view showing a transmission cable according to a second modified example of the embodiment.

In this second modified example, both pairs of signal wire pairs 3 are arranged so that a flat surface 35 among the surfaces constituting the outer circumference comes into contact with a twisted-pair signal wire 2. A surface 36, which is on the opposite side to the surface 35, among the outer circumferential surfaces of the two pairs of signal wire pairs 3 comes into contact with the inner circumferential surface of a shield material 7.

According to this configuration, since the cables of a transmission cable 1 are arranged in a more balanced manner, damage to these cables is prevented.

### Second Embodiment

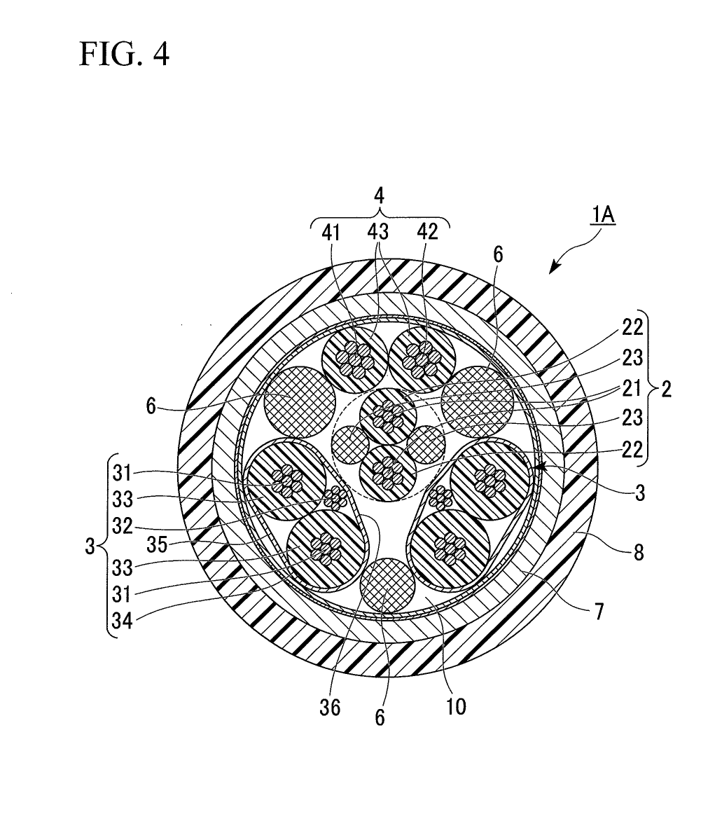

FIG. 4 is a cross-sectional view showing a transmission cable 1A according to a second embodiment of the present invention.

In the transmission cable 1A according to this embodiment, two first inclusions 23 are arranged along a twisted-pair signal wire 2 which is arranged at the center so as to sandwich the contact point of the twisted-pair signal wire 2 in between. Two signal wires 21 and two first inclusions 22 for a total of four are twisted together and quad-twisted.

The outer diameter of the first inclusion is 0.55 mm and the material for the first inclusion is polypropylene (PP).

The other configurations are the same as those in the above-described first embodiment. The twisted-pair signal wire 2 is arranged at approximately the center of a cross-section vertical to the longitudinal direction of the transmission cable 1, and signal wire pairs 3 and a power wire pair 4 are arranged therearound in a helical shape. The signal wire pair 3 is preferably a twin-axial cable in which signal wires are bundled together parallel to each other, but may be a STP cable which is a twisted-pair wire.

The cross-sectional shape of the twisted-pair signal wire 2 is made close to a true circle by adding and quad-twisting the two first inclusions 23. Accordingly, when the two pairs of signal wire pairs 3 and the power wire pair 4 are arranged around the twisted-pair signal wire 2, these can be arranged in a more balanced manner and damage to the signal wires is more securely prevented.

In addition, both the two pairs of signal wire pairs 3 are arranged so that a flat surface 35 among the surfaces constituting the outer circumference comes into contact with the inner circumferential surface of a shield material 7. A surface 36, which is on the opposite side to the surface 35, among the surfaces constituting the outer circumference comes into contact with the twisted-pair signal wire 2.

According to this configuration, since the cables of the transmission cable 1 are arranged in a more balanced manner, damage to these cables is more securely prevented.

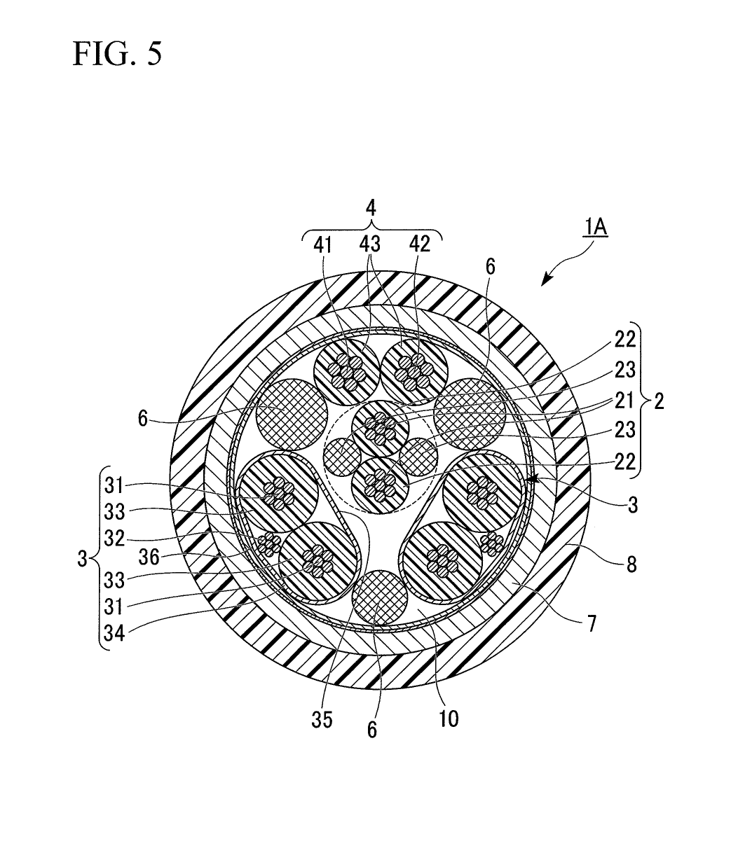

FIG. 5 is a cross-sectional view showing a transmission cable according to a modified example of the embodiment.

In this modified example, both pairs of signal wire pairs 3 are arranged so that a flat surface 35 among the surfaces constituting the outer circumference comes into contact with a twisted-pair signal wire 2. A surface 36, which is on the opposite side to the surface 35, among the surfaces constituting the outer circumference of the signal wire pair 3 comes into contact with the inner circumferential surface of a shield material 7.

According to this configuration, since the cables of the transmission cable 1 are arranged in a more balanced manner, damage to these cables is more securely prevented.

According to a transmission cable of the present invention, it is possible to prevent deterioration in attenuation characteristics due to the damage to the cable and to provide a USB cable in conformity with the USB 3.0 standard.

1. A transmission cable comprising:
a twisted-pair signal wire;
a plurality of signal wire pairs; and
a power wire pair,
wherein the twisted-pair signal wire, the plurality of signal wire pairs, and the power wire pair are bundled together so that the twisted-pair signal wire is surrounded by the plurality of signal wire pairs and the power wire pair when viewed in cross-section vertical to a longitudinal direction thereof.

2. The transmission cable according to claim 1, further comprising
a pair of first inclusions provided which sandwiches a contact point of the twisted-pair signal wire in between, wherein
the twisted-pair signal wire and the pair of first inclusions are quad-twisted.

3. The transmission cable according to claim 1, further comprising
a second inclusion arranged between the respective signal wire pairs and the power wire pair and between the signal wire pairs.

4. The transmission cable according to claim 1,
wherein the signal wire pairs are twin-axial cables.

5. The transmission cable according to claim 1,
wherein the signal wire pairs are STP cables.

6. The transmission cable according to claim 1,
wherein the twisted-pair signal wire is a twisted-pair signal wire constituting a UTP cable for USB 2.0 standard, and
the transmission cable is a USB cable in conformity with USB 3.0 standard.
